(19) United States
(12) Patent Application Publication
(10) Pub. No.: US 2015/0244230 A1
(43) Pub. Date: Aug. 27, 2015

(54) ALTERNATOR INCLUDING A STATOR CORE WITH SLOT LINERS

(71) Applicant: REMY TECHNOLOGIES, L.L.C., Pendleton, IN (US)

(72) Inventors: Suk-Jun Yoon, HamanGun (KR); Kirk Neet, Pendleton, IN (US)

(73) Assignee: REMY TECHNOLOGIES, L.L.C., Pendleton, IN (US)

(21) Appl. No.: 14/190,639

(22) Filed: Feb. 26, 2014

(51) Int. Cl. H02K 3/34; H02K 15/10; H02K 15/06; H02K 15/02

(52) U.S. Cl. CPC H02K 3/345; H02K 15/024; H02K 15/105; H02K 15/062

(57) ABSTRACT

A stator core includes a plurality of stator teeth. The plurality of stator teeth defines a plurality of slots. Each of the plurality of slots includes a first side, a second side, and a base joining the first and second sides. A slot liner is arranged in at least one of the plurality of slots. The slot liner includes a first side portion, a second side portion, and a base portion. The first side portion extends from a first end to a second end joining the base portion through a first intermediate portion. The second side portion extends from a first end to a second end joining the base portion through a second intermediate portion. A bend is formed in the first intermediate portion. The bend creates a gap between the first side portion and the first side.

### BACKGROUND OF THE INVENTION

Exemplary embodiments pertain to the art of electric machines and, more particularly, to a stator core including slot liners.

Many motor vehicles include an alternator that transforms mechanical energy into electrical energy that is used to charge an onboard battery. Generally, alternators include a rotor having rotor windings that are rotated within a stator having stator windings. The rotor may include a pair of slip rings that are electrically coupled to the rotor windings. When the rotor is rotated within the stator, an electrical field is developed inducing an electrical current in the stator windings. The stator windings are arranged in slots formed in a core. In some cases, the slots may be provided with slot liners that protect the stator windings during installation.

### BRIEF DESCRIPTION OF THE INVENTION

Disclosed is a stator core including a body including a radially outwardly facing surface and a radially inwardly facing surface and a plurality of stator teeth extending from the radially inwardly facing surface of the body to a cantilevered end. The plurality of stator teeth is spaced about the radially inwardly facing surface defining a plurality of slots. Each of the plurality of slots includes a first side defined by one of the plurality of stator teeth, a second side defined by an adjacent one of the plurality of stator teeth, and a base joining the first and second sides. A slot liner is arranged in at least one of the plurality of slots. The slot liner includes a first side portion, a second side portion, and a base portion. The first side portion extends from a first, cantilevered end to a second end joining the base portion through a first intermediate portion. The second side portion extends from a first, cantilevered end to a second end joining the base portion through a second intermediate portion. A bend is formed in the first intermediate portion. The bend creates a gap between the first side portion and the first side.

Also disclosed is an alternator including a housing, and a stator core arranged within the housing. The stator core includes a body having a radially outwardly facing surface and a radially inwardly facing surface. A plurality of stator teeth extend from the body. Each of the plurality of stator teeth extend from the radially inwardly facing surface to a cantilevered end. The plurality of stator teeth is spaced about the radially inwardly facing surface defining a plurality of slots. Each of the plurality of slots include a first side defined by one of the plurality of stator teeth, a second side defined by an adjacent one of the plurality of stator teeth, and a base joining the first and second sides. A slot liner is arranged in at least one of the plurality of slots. The slot liner includes a first side portion, a second side portion, and a base portion. The first side portion extends from a first, cantilevered end to a second end joining the base portion through a first intermediate portion. The second side portion extends from a first, cantilevered end to a second end joining the base portion through a second intermediate portion. A bend is formed in the first intermediate portion. The bend creates a gap between the first side portion and the first side.

Further disclosed is a method of forming a stator core including forming a slot liner having a first side portion and a second side portion joined by a bend portion. The first side portion is spaced from the second side portion forming an opening. The method also includes flaring the opening of the slot liner, inserting the slot liner into a stator slot defined between first and second stator teeth, and guiding a plurality of stator windings into the stator slot.

### BRIEF DESCRIPTION OF THE DRAWINGS

The following descriptions should not be considered limiting in any way. With reference to the accompanying drawings, like elements are numbered alike:

FIG. 1 depicts an elevational view of an electric machine including a stator having slot liners, in accordance with an exemplary embodiment;

FIG. 2 depicts a perspective view of the stator of FIG. 1;

FIG. 3 depicts a slot liner, in accordance with an exemplary embodiment;

FIG. 4 depicts the slot liner of FIG. 3 installed into a stator slot;

FIG. 5 depicts stator windings installed into the stator slot of FIG. 4; and

FIG. 6 depicts the slot liner of FIG. 3 installed into a stator slot, in accordance with another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

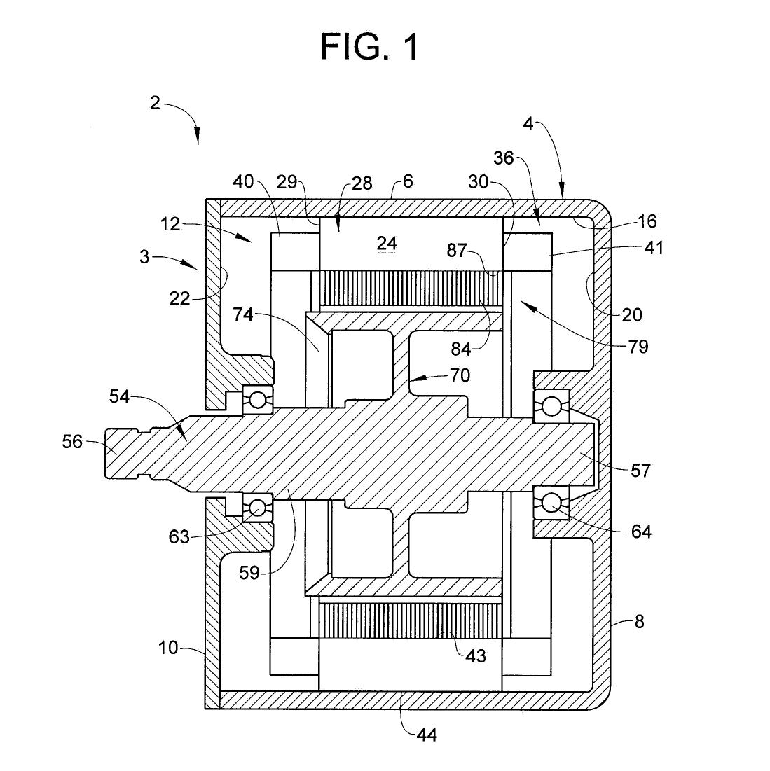

An electric machine, in accordance with an exemplary embodiment, is indicated generally at 2, in FIG. 1. Electric machine 2 takes the form of an alternator 3 including a housing 4 having a side wall 6 that is joined by a first end wall 8 and a second end wall, or cover 10 to collectively define an interior portion 12. Side wall 6 includes an inner surface 16. In addition, first end wall 8 includes an inner surface 20 and second end wall 10 includes an inner surface 22. Electric machine 2 is further shown to include a stator 24 arranged at inner surface 16 of first side wall 6. Stator 24 includes a body 28, having a first end portion 29 that extends to a second end portion 30, which supports a plurality of windings 36. Windings 36 include a first end turn portion 40 and a second end turn portion 41. Body 28 also includes a radially inwardly facing surface 43 and a radially outwardly facing surface 44.

Electric machine 2 is also shown to include a shaft 54 rotatably supported within housing 4. Shaft 54 includes a first end 56 that extends to a second end 57 through an intermediate portion 59. First end 56 is rotatably supported relative to second end wall 10 through a first bearing 63 and second end 57 is rotatably supported relative to first end wall 8 through a second bearing 64. Shaft 54 supports a rotor assembly 70 that is rotatably mounted within housing 4. Rotor assembly 70 includes a hub 74 that is fixed relative to intermediate portion 59, and a rotor lamination assembly 79. Rotor lamination assembly 79 includes a plurality of laminations 84 that are stacked and aligned to define an outer diametric surface 87 that is spaced from radially inwardly facing surface 43 of stator 24.

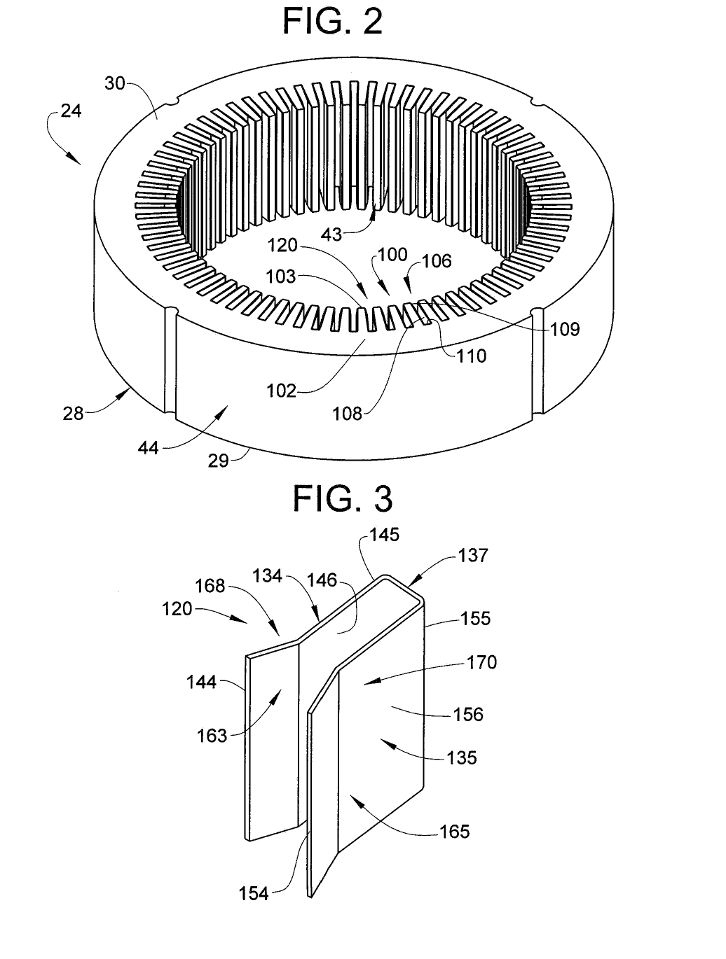

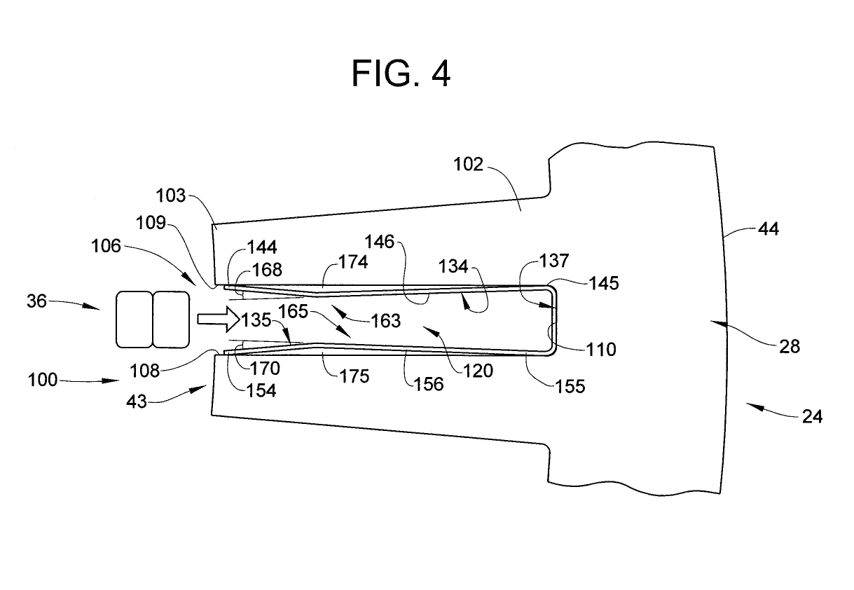

As best shown in FIG. 2, stator 24 includes a plurality of stator teeth 100 that extend radially inwardly from body 28. Each stator tooth 100 extends from a first end 102 to a second, cantilevered end 103. Second, cantilevered end 103 defines a portion of radially inwardly facing surface 43. Adjacent ones of the plurality of stator teeth 100 define a plurality of stator slots, one of which is indicated at 106. Each stator slot 106 includes a first side 108, a second side 109 and a base 110. In the exemplary embodiment shown, each stator slot 106 is provided with a slot liner 120 that electrically insulates windings 36 from body 28.

In accordance with an exemplary embodiment illustrated in FIG. 3, slot liner 120 includes a first side portion 134, a second side portion 135 and a base portion 137. First side portion 134 extends from a first, cantilevered end 144 to a second end 145 through a first intermediate portion 146. Second end 145 joins with base portion 137. Second side portion 135 extends from a first, cantilevered end 154 to a second end 155 through a second intermediate portion 156. Second end 155 joins with base portion 137. First side portion 134 includes a first bend 163 in first intermediate portion 146. Similarly, second side portion 135 includes a second bend 165 in second intermediate portion 156.

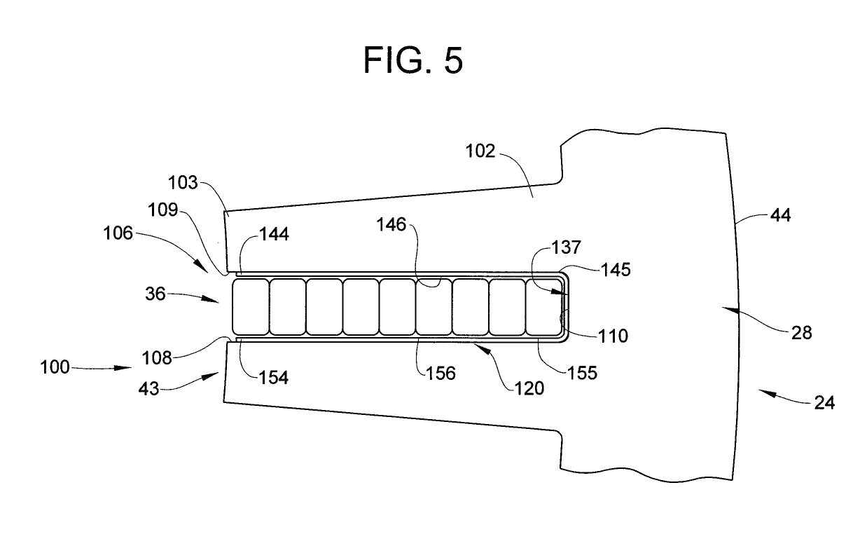

First bend 163 establishes a first angle 168 of first end 144 relative to second end 145. Second bend 165 establishes a second angle 170 of first end 154 relative to second end 155. When slot liner 120 is installed in slot 106, first angle 168 intersects with first side portion 134 and second angle 170 intersects second side portion 135. Further, first bend 163 creates a first gap 174 between first intermediate portion 146 and first side portion 134, and second bend 165 creates a second gap 175 between second intermediate portion 156 and second side portion 135. In this manner, first ends 144 and 154 flare outwardly allowing windings 36 to pass into slot 106 without deforming slot liner 120, as shown in FIG. 5. Further, first and second bends or creases 163 and 165 enable windings 36 to be inserted into slot 106 without the need to adhesively join slot liner 120 to stator teeth 100.

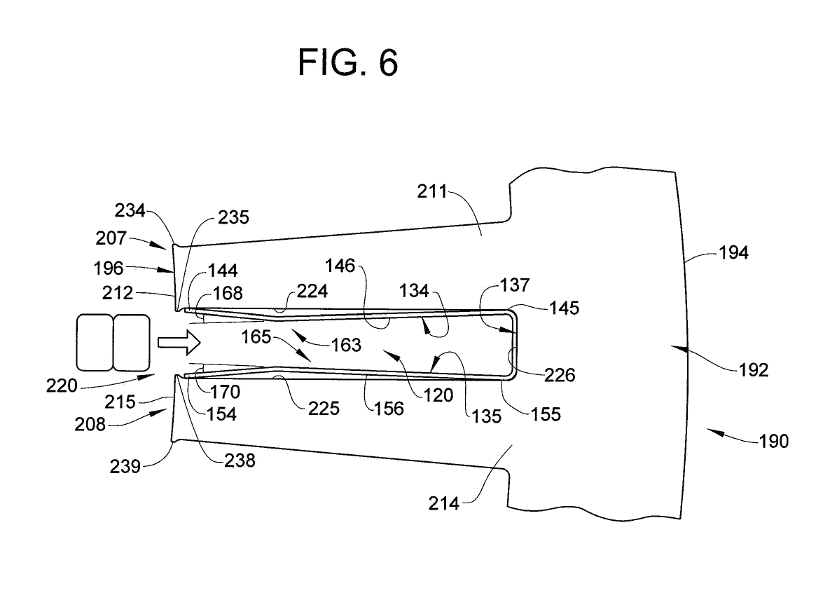

Reference will now follow to FIG. 6 in describing a stator 190, in accordance with another aspect of an exemplary embodiment. Stator 190 includes a body 192 including a radially outwardly facing surface 194 and a radially inwardly facing surface 196. Stator 190 includes a plurality of stator teeth, two of which are shown at 207 and 208. Stator tooth 207 extends from a first end 211 to a second, cantilevered end 212. Stator tooth 208 extends from a first end 214 to a second, cantilevered end 215. A slot 220 is formed between stator tooth 207 and stator tooth 208.

Slot 208 includes a first side 224, a second side 225 and a base 226. Second end 212 includes first and second opposing cap elements 234 and 235. Similarly, second end 215 includes first and second opposing cap elements 238 and 239. Cap element 235 extends into slot 220 from first side 224 and cap element 238 extends into slot 220 from second side 225. Slot liner 120 is installed in slot 220. In accordance with an exemplary embodiment, first bend 163 positions first end 144 of first side portion 134 against first side 224. Similarly, second bend 165 positions first end 154 of second side portion 135 against second side 225. In this manner, cap element 235 covers first end 144 and cap element 238 covers first end 154. In this manner, cap elements 235 and 238 shield first ends 144 and 154 when windings 36 are installed into slot 220 thereby avoiding the need to adhesively join slot liner 120 to stator teeth 207 and 208.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A stator core comprising:
a body including a radially outwardly facing surface and a radially inwardly facing surface;
a plurality of stator teeth extending from the body, each of the plurality of stator teeth extending from the radially inwardly facing surface to a cantilevered end, the plurality of stator teeth being spaced about the radially inwardly facing surface defining a plurality of slots, each of the plurality of slots including a first side defined by one of the plurality of stator teeth, a second side defined by an adjacent one of the plurality of stator teeth, and a base joining the first and second sides; and
a slot liner arranged in at least one of the plurality of slots, the slot liner including a first side portion, a second side portion, and a base portion, the first side portion extending from a first, cantilevered end to a second end joining the base portion through a first intermediate portion, the second side portion extending from a first, cantilevered end to a second end joining the base portion through a second intermediate portion, a bend formed in the first intermediate portion, the bend creating a gap between the first side portion and the first side.

2. The stator core according to claim 1, wherein the bend creates an angle at the first end of the first side portion, the angle intersecting the first side.

3. The stator core according to claim 2, further comprising: at least one winding arranged in the slot, the at least one winding urging the first portion towards the first side substantially eliminating the gap.

4. The stator core according to claim 1, further comprising: another bend formed in the second intermediate portion, the another bend creating a gap between the second side portion and the second side.

5. The stator core according to claim 3, wherein the another bend creates an angle at the first end of the second side portion, the angle intersecting the second side.

6. The stator core according to claim 1, further comprising: a plurality of cap elements formed on the cantilevered end of each of the plurality of stator teeth, the plurality of cap elements including a first cap element extending from one of the plurality of stator teeth into one of the plurality of slots and a second cap element extending from another of the plurality of stator teeth into the one of the plurality of slots.

7. The stator core according to claim 5, wherein the first end of the slot liner is shielded by the first cap element and the second end of the slot liner is shielded by second cap element.

8. The stator core according to claim 1, further comprising: at least one winding arranged in the slot, the at least one winding urging the first and second side portions toward corresponding ones of the first and second sides substantially eliminating the gap.

9. An alternator comprising:
a housing; and
a stator core arranged within the housing, the stator core comprising:
a body including a radially outwardly facing surface and a radially inwardly facing surface;
a plurality of stator teeth extending from the body, each of the plurality of stator teeth extending from the radially inwardly facing surface to a cantilevered end, the plurality of stator teeth being spaced about the radially inwardly facing surface defining a plurality of slots, each of the plurality of slots including a first side defined by one of the plurality of stator teeth, a second side defined by an adjacent one of the plurality of stator teeth, and a base joining the first and second sides; and
a slot liner arranged in at least one of the plurality of slots, the slot liner including a first side portion, a second side portion, and a base portion, the first side portion extending from a first, cantilevered end to a second end joining the base portion through a first intermediate portion, the second side portion extending from a first, cantilevered end to a second end joining the base portion through a second intermediate portion, a bend formed in the first intermediate portion, the bend creating a gap between the first side portion and the first side.

10. The alternator according to claim 9, wherein the bend creates an angle at the first end of the first side portion, the angle intersecting the first side.

11. The alternator according to claim 9, further comprising: another bend formed in the second intermediate portion, the another bend creating a gap between the second side portion and the second side.

12. The alternator according to claim 11, wherein the another bend creates an angle at the first end of the second side portion, the angle intersecting the second side.

13. The alternator according to claim 9, further comprising: a plurality of cap elements formed on the cantilevered end of each of the plurality of stator teeth, each of the plurality of cap elements including a first cap element extending from one of the plurality of stator teeth into one of the plurality of slots and a second cap element extending from another of the plurality of stator teeth into the one of the plurality of slots.

14. The alternator according to claim 13, wherein the first end of the slot liner is shielded by the first cap element and the second end of the slot liner is shielded by the second cap element.

15. The stator core according to claim 14, further comprising: at least one winding arranged in the slot, the at least one winding urging the first and second side portions toward corresponding ones of the first and second sides substantially eliminating the gap.

16. A method of forming a stator core comprising:
forming a slot liner including a first side portion and a second side portion joined by a bend portion, the first side portion being spaced from the second side portion forming an opening;
flaring the opening of the slot liner;
inserting the slot liner into a stator slot defined between first and second stator teeth; and
guiding a plurality of stator windings into the stator slot.

17. The method of claim 16, wherein flaring the opening of the slot liner includes forming a bend in one of the first and second side portion.

18. The method of claim 16, wherein flaring the opening of the slot liner includes forming a first bend in the first side portion and a second bend in the second side portion.

19. The method of claim 16, wherein flaring the opening of the slot liner includes forming an angle in the first side portion intersecting an adjacent side of the stator slot.

20. The method of claim 16, wherein flaring the opening of the slot liner includes forming a first angle in the first side portion intersecting a first side of the stator slot and forming a second angle in the second side portion intersecting a second side of the stator slot.

21. The method of claim 16, further comprising: forming a first cap element on a cantilevered end of the first stator tooth and a second cap element on a cantilevered end of the second stator tooth.

22. The method of claim 21, wherein inserting the slot liner into the stator slot includes positioning a first end of the first side portion behind the first cap element and a first end of the second side portion behind the second cap element.

23. The method of claim 22, wherein guiding a plurality of stator windings into the stator slot includes guiding a plurality of stator windings into the stator slot with the slot liner not being bonded to the stator core.

24. The method of claim 22, wherein guiding the stator winding into the slot includes shifting the stator winding radially into a slot formed in an annular stator core.
